(19) United States
(12) Patent Application Publication
(10) Pub. No.: US 2021/0172118 A1
(43) Pub. Date: Jun. 10, 2021

(54) Repulping Method For The Removal Of Lignocellulosic Hornification

(71) Applicant: Sanata Technologies Inc., Burnaby (CA)

(72) Inventor: Salah Awadel-Karim, Burnaby (CA)

(73) Assignee: Sanata Technologies Inc., Burnaby (CA)

(21) Appl. No.: 16/706,610

(22) Filed: Dec. 6, 2019

(51) Int. Cl. D21C 3/20; D21C 9/00

(52) U.S. Cl. CPC D21C 3/20; D21C 9/007; D21C 9/005

(57) ABSTRACT

This invention uses lignin, which is the main chemical by-product of the original pulping process in manufacturing wood pulp for use in cardboard and paper, to create a repulping solution Lignocellulosic Hornification Remover (“LHR”) comprising a customized mixture of dipolar aprotic such as dimethyl sulfoxide (DMSO) and water, the LHR having greater frequency and energy and lignocellulosic hornification removal results than pure DMSO or other cellulose swelling chemical agents previously used in conventional repulping. The LHR creates and secures a special type of swelling (“intramicellar swelling”) in the material being re-pulped. Intramicellar swelling is a dimensional type of swelling, not the normal swelling of pulp material which is a directional one. The intramicellar swelling influences and breaks down both the intra- and intermolecular H-bonds of both amorphous and crystalline cellulose (i.e., cellulose micelle crystallites) and renders accessible cellulose with open H-bond packing in the material being re-pulped. As intramicellar swelling is attained, the following desirable features in the material being re-pulped occur: increased flexibility of fibers, opening of H-bonding, detachment of ink, additives and adhesives.

### FIELD OF THE INVENTION

This invention relates to pulping by-product utilization, treatment of water and the repulping of lignocellulosic products.

### BACKGROUND OF THE INVENTION

In the pulp and paper manufacturing industry water is used extensively and is a vital element of the process of pulping and repulping lignocellulosic products. It is used for dissolving pulp, and as a component in loading, sizing, and coloring ingredients as well as in the transportation of pulp fibers through the manufacturing process as it moves through storage tanks, screens, refiners and paper-making machines.

The current process of repulping paper involves pulping, screening, cleaning, and de-inking by processes like bleaching and the application of alkaline chemicals which contaminate the water. Waste paper treatment methods are variable depending on the type of paper and may involve de-inking of toner from laser printers or photocopiers, or the removal of other contaminants from the paper.

Pollution sometimes causes water molecules to form into large clusters which surround molecules of pollutant due to hydrogen bonding. Even after most of the pollutant molecules have been removed there can still be clustering of water molecules due to residual electrostatic interference. This clustering can reduce the capacity of the water to dissolve, carry, and transport solutes including pulps and can also cause it to become anaerobic, i.e., reducing its capacity to support marine life.

Hence, the use of low capacity water and alkaline medium (1% NaOH) in the conventional repulping process bring about low productivity (i.e., considerable fiber losses), inferior quality of finished paper products, consumption of unnecessary chemicals with regards to strength and other physical properties as well. Also, environmental concerns are a result of the use of current re-pulping technology.

With the current trend towards sustainability and the increasing scale of the pulp and paper industry, these problems are becoming increasingly relevant. As sustainable and environmental standards tighten, new methods of effective repulping of lignocellulosic products and that are less harmful to water quality and methods of treating wastewater to restore its quality are increasingly needed.

The formation of supramolecular lateral order H-bonding of crystalline cellulose (“Lignocellulosic Hornification”) in material being re-pulped is the most difficult feature to overcome that occurs during the repulping process and is the root cause of the shortcomings of conventional repulping technology in both paper recycling and market pulp, i.e., high consumption of chemicals, water, energy, virgin pulp, inferior quality of finished products and low productivity. In addition, the conventional repulping technology is associated with environmental concerns.

In prior conventional repulping, chemicals such as neutral and alkaline swelling agents are used but are not efficient enough to influence and break down Lignocellulosic Hornification during the repulping process.

### BRIEF SUMMARY OF THE INVENTION

This invention uses lignin, which is the main chemical by-product of the original pulping process in manufacturing wood pulp for use in cardboard and paper, to create a repulping solution Lignocellulosic Hornification Remover (“LHR”) comprising a customized mixture of dipolar aprotic such as dimethyl sulfoxide (DMSO) and water, the LHR having greater frequency and energy and lignocellulosic hornification removal results than pure DMSO or other cellulose swelling chemical agents previously used in conventional repulping.

The LHR creates and secures a special type of swelling (“intramicellar swelling”) in the material being re-pulped. Intramicellar swelling is a dimensional type of swelling, not the normal swelling of pulp material which is a directional one. The intramicellar swelling influences and breaks down both the intra- and intermolecular H-bonds of both amorphous and crystalline cellulose (i.e., cellulose micelle crystallites) and renders accessible cellulose with open H-bond packing in the material being re-pulped.

As intramicellar swelling is attained, the following desirable features in the material being re-pulped occur: increased flexibility of fibers, opening of H-bonding, detachment of ink, additives and adhesives.

The LHR, which provides intramicellar swelling repulping, is also ideal in an economic sense because it is a direct replacement of all the chemicals used in conventional repulping methods (neutral and alkaline methods) and provides higher quality, yield and efficiency at a lower chemical cost.

Through intramicellar swelling, the LHR-induced repulping is capable of rendering flexible and conformable cellulose with minimum stress and deformation. This quality cellulose, using nano-fiber analysis, can be demonstrated in enhanced average fiber weighted length, higher coarseness, lower curl and kink indices and fairly high percentage of side branching of microfibrils (i.e., <0.2 mm).

In reality, these acquired and achieved properties of the repulped material lead to production sustainability; clean non-fibrous rejects, increased productivity, substantial hemicellulose retention, greater wet strength and high quality strength and physical properties of finished products, magnificent sheet formation, less water and energy consumptions LHR is not a readymade or standard repulping solution for all lignocellulosic materials required to be repulped. To attain the ideal intramicellar swelling condition for each repulped cellulosic material, LHR is used in a repulping mixture comprised of DMSO and water at the initial agitator vat where the percentage of DMSO and water are to be optimized depending on the following:

1. Type of lignocellulosic material to be repulped;

2. The desired characteristics of the pulp resulting from the process.

In the production of the LHR, DMSO is the most ideal one among all dipolar aprotic solvents. On the other hand, DMSO is a naturally occurring lignin derivative compound which it appears to be a part of earth's complex sulfur cycle. The original and stirring motivation behind this invention idea is the unique function of the Sulfur element in the DMSO molecule and all chemical pulping solutions as well. Indeed, it is the most effective agent for cellulosic fiber separation in both pulping and repulping processes.

This invention provides a new method of efficient repulping using LHR in an agitator vat, or pulper, with optimization of process variables depending on the reactivity of LHR quality, type of material being re-pulped and the desired characteristics of the pulp resulting from the process. The mechanism of lignocellulosic materials repulping in LHR is based on physical reactions of the LHR, first with water from one part of the solvent and second LHR with cellulosic material from the other part of the solvent.

The invention is designed to provide an enhanced method of repulping lignocellulosic products using the main by-product of a pulping process, that is, lignin, in the production of the LHR. The innovative repulping solution, a more reactive and improved solution can be obtained by the interaction of a lignin derivative compound, DMSO, with water. These objects are discussed in relevance to their role in the repulping process; first with respect to the essential water quality improvement objects are to increase its reactivity and solvent capacity. This has numerous advantages as first discussed below under the title: “LHR—Quality and Advantages”, and second, the primary repulping objects are to reduce fiber losses and improve pulp quality by eliminating hornification. There are a number of aspects related to this as discussed below.

### BRIEF DESCRIPTION OF THE DRAWINGS

FIG. 1 is an illustration of the formation of the LHR molecule i.e., 6-water molecule cluster using a dipolar aprotic solvent (DMSO, having the formula (CH₃)₂SO).

FIG. 2a is a diagram showing LHR targeting the inter- and intra-molecular H-bonds of cellulose molecules in repulpable material. FIG. 2b is a diagram showing the effect of LHR on the H-bonds of cellulose.

FIG. 3a is an illustration of the stretch of an H-bond from 104.51 degrees to 109.47 degrees as a result of the influence of LHR. FIG. 3b shows the adoption of an H-bond angle tetrahedral form caused by the influence of LHR.

FIG. 4 is a block diagram outlining the steps of the effective repulping method of this invention.

FIG. 5 is an illustration of the processes of the effective repulping method.

FIG. 6a is a diagram showing some of the equipment used to implement the methods of this invention. FIG. 6b is a diagram showing some of the control, testing and optimization apparatus used in this invention. (Note: FIGS. 6a & 6b are connected at 110).

FIG. 7a is an illustration showing the chemistry of prior DMSO repulping solutions in recycling of cellulose, and FIG. 7b is an illustration showing the chemistry of the LRH solution of the present invention.

FIG. 8a is an illustration showing the hornification of recycled lignocellulosic fiber using prior repulping methods, and FIG. 8b is an illustration showing de-hornification of recycled lignocellulosic fiber using the LHR method of the present invention.

### DETAILED DESCRIPTION

Relevant issues affecting water quality and treatment will now be introduced as a necessary context for the detailed description. These issues will include the Status of Today's Water Quality; Repulping of Paper Products using Conventional Methods; Hornifiation—Deformation of H-bonds Phenomenon in Drying; Market Pulp; Effect of Repulping Medium on Hornification; and the Effect of Repulping Medium on Cellulose.

Status of Today's Water Quality:

Water as a natural resource, is a vital element and necessity in the manufacture of pulp, paper and paperboard and for the generation of power in the industry's steam plants. Mills using up to 350 cubic meters per ton of paper are not uncommon in pulp and paper industry. A large percentage of the water requirements for the mills come from surface supplies, i.e., rivers and lakes and the remainder comes from wells of a few feet to over a number of thousand feet deep. Good quality water in large quantities is as essential to the manufacture of pulp and paper as cellulose. As a matter of fact, water is one of the most critical of all materials used by the pulp and paper industry. It is used directly in the processing of pulp, it dissolves or is mixed with the various loading, sizing and coloring ingredients; and in addition, it is the medium which carries the fibers through the storage tanks, screens and the refiners to the paper-making machine where it plays the most important role in the making of a sheet of paper. Therefore, the current paper industry grade water is required to possess the following norms:

pH=˜6.8
Total dissolved solids (TDS)=˜280 mg/l
Total suspended solids (TSS)=0 mg/l
Biological oxygen demand (BOD)=0 mg/l
Chemical oxygen demand (COD)=0 mg/l

### Color (RCO)=nil

### Turbidity (NTU)=nil

Hardness (as CaCO₃)=˜180 mg/l

However, today's water (including paper industry grade water) has encountered serious pollution problems. Pollution causes water molecules to gather together in larger clusters than they would naturally be, and hence as the water “wraps up” dissolves the pollutant. Even if the pollutant is filtered the water molecule cluster still remains in unnaturally large cluster due to its lasting electromagnetic frequency influence on the water, this frequency keeps the water molecules in the same unnatural structure.

Water pollution comes in many forms such as chemicals, thermal, septic system, farm run-off, frictional and electromagnetic radiation. Even methods or devices that we typically use for the removal of pollution from water are themselves contribution to water pollution on the molecular/frequency level. On the one hand, pollution saturates water with unnatural amounts of substances and electromagnetic influences that all leave their implications in the form of low frequency on water, reducing its capacity to dissolve, carry, transport and be less microbiologically stable (e.g., improved environment for bacteria and enzyme to grow and proliferate). On the other hand, pollution has made today's H—O—H angle to shrink from 109.47 to 104.51 and this shrinkage renders water with less reactivity. As water becomes over polluted it can no longer clean or regenerate itself, it is simply too full of the frequency influence of pollution, causing larger than natural water molecule clusters (i.e., free oxygen trappers). If water cannot dissolve and transport oxygen effectively it can become anaerobic.

Repulping of Paper Products Using Conventional Methods:

The global demand for paper and paperboard has risen steadily in recent years and is expected to continue to rise. This demand increase has coincided with a decrease in the supply of pulp-producing timber due to deforestation and global warming. The result of these two factors is increased demand for recycled paper. Pulp for recycled paper is typically obtained by applying various neutral and alkaline pulping processes with bleaching conditions selected in the attempt to obtain some of the following desired qualities for the resultant pulp:
High yield of recovered fibers;
Suitable amount of surface adsorbed hemicellulose;
Specific strength properties;
High levels of brightness;
Sufficient smoothness.

The feasibility of manufacture of recycled pulp and its competitiveness is largely dependent on the yield and the quality of the pulp from a given amount of waste paper as starting material. The quantity of the recovered pulp and the characteristics of the fibrous material (i.e., no less than those of the virgin pulp) represent important parameters of the recycled pulp. However, the losses during repulping (pulping, screening and cleaning, kneading, soaking, flotation, washing, de-inking, and bleaching) operations are fairly high and account for a remarkable shrinkage in industrial revenue due to the considerably low pulp yield and inferior fiber quality. Current alkali and neutral treatment technologies are quite inefficient for repulping of market pulp and waste paper. Methods for attainment of high quality pulp from the recycled paper are complex and a number of schemes for pulping and bleaching of recycled paper materials with various, chemicals, oxidizing and reducing agents have been proposed, but have resulted in yield and the quality of the recovered fibrous material being still far below the desirable norms.

Current repulping and bleaching operations generally include pulping, screening, cleaning, and de-inking by a combination of kneading, soaking, flotation and washing. In some cases, depending on the end-use, the bleaching follows. However, each mill typically has its own technological line that differs from the others, depending on the type, quality of waste paper, required finished product and the individual mill's condition. There is usually no tailor-made process for waste paper treatment. This is due to the fact that most technical problems change with time. On the other hand, the conventional technology responds to this drawback in a piecemeal manner with limited results, using, for swelling water, 1% NaOH solution and sodium silicate, for de-inking fatty acids and several surfactants, for adhesives different de-tackifying agents, for strength properties starch and other synthetic polymers. All in all, the short-comings associated with the recovered fibers in prior re-pulping methods are due to fiber hornification.

Hornification—Deformation of H-Bonds Phenomenon in Drying:

The term “hornification” is a technical term used in wood pulp and paper research literature that refers to the stiffening of the polymer structure that takes place in lignocellulosic materials upon drying or water removal. When wood pulp fibers are dried, the internal fiber volume shrinks, because of structural changes in wood pulp fibers. If fibers are resuspended in water, the original water-swollen state would not be regained. The effect of hornification can be identified in those physical paper or wood pulp properties that are related to normal/hydration swelling, such as burst or tensile properties. Hence repeated recycling showed continuing variations in these properties for several cycles.

From the anatomical point of view, most important wood cells are longitudinal tracheids in softwoods (Conifers—Gymnosperms), while libriform fibers are dominating in hardwoods (Dicot Angiosperms). These cells are often referred to as fibers. Besides, there is a great amount of ray cells in softwoods, while ray cells and vessels exist in hardwoods. They are important for transport and storage of water and nutrients. Pits are also present in both types of woods. They function as passages for water between two neighboring cells.

The fiber cell wall consists of two phases; a fibrillar phase and matrix phase. The fibrillar phase functions as a kind of reinforcement and is composed of cellulose microfibrils, while the matrix phase is distinguished by consisting of hemicellulose and lignin. The cell wall layers are generally characterized by the angular orientation of microfibrils. Hornification can be detected in both microfibril angle deformation or microfibril aggregates which affect both intra- and intermolecular hydrogen bonds.

With regard to microfibril angles in amorphous and crystalline regions of cellulose are fairly distinguishable. The crystalline cellulose is primarily characterized by the very acute microfibril angles (i.e., between 0° and 30°), while the angles in the amorphous cellulose are wider than those of the crystalline one. They are in the range of 60° to 90°.

The secondary cell wall is comprised of three different cell wall layers (i.e., S1, S2 and S3), where the S2 layer dominates. Its constitutive components are: cellulose, hemicelluloses and lignin. Orientation of the polymers in the S2 layer is of importance for the functional characteristics of the entire cell wall, because the S2 layer makes up to 75%-85% of the total thickness of the cell wall. It is well known that the cellulose chains are mainly arranged in a more or less parallel direction (0° to 30°) to the fiber axis in the major part of the fiber wall, i.e. the S2 layer. The orientation of the hemicelluloses and lignin is determined by the orientation of the cellulose microfibrils. Many of the hemicellulose molecules are oriented in parallel with cellulose and that they coat the cellulose microfibrils, while other hemicellulose molecules are randomly dispersed in the space between the cellulose microfibrils, and/or one molecule of the hemicellulose can be partly attached to cellulose microfibril with the portions that can extend into the matrix and covalently bond to lignin. In order to better understand the interactions between these polymers, cellulose and hemicellulose are non-covalently bonded (i.e., H-bonded), while lignin and hemicellulose are covalently bonded (i.e., lignin carbohydrate complex—LCC).

In this context, the cellulose molecules have a strong tendency to form intermolecular and intra-molecular hydrogen bonds. Two intra-molecular hydrogen bonds, i.e., O2-H¼O6 and O3H¼O5, and one intermolecular hydrogen bond, i.e., O6-H¼O3, exist. This parallel hydrogen bonded structure of the chain cellulose molecules form what is called microfibrils. The bundle aggregations of the microfibrils are referred to as microfibril aggregates. They have variable dimensions in the cell wall of wood. This structure of the cellulose is responsible for the longitudinal tensile strength of wood fibers.

Furthermore, the conventional repulping media (i.e., neutral and alkaline solutions) are not efficient enough to influence the supramolecular structure H-bonding of the crystalline cellulose, and hence with the employment of normal water (paper industry grade water) and alkaline solution (1% NaOH) in pulping of recycled paper intramicellar swelling cannot be attained.

This invention secures intramicellar swelling which is a dimensional type of swelling that can be achieved by applying the effective pulping medium i.e., LHR. DMSO reactive water is of high frequency and energy (i.e. oxygen rich water of small water molecule clusters). This type of swelling is to influence the H-bonding (i.e., intra- and intermolecular) of both amorphous and crystalline cellulose (i.e., cellulose micelle crystallites) and render accessible cellulose with open H-bond packing.

Market Pulp:

Hornification phenomenon is also associated with the market pulp which is produced in dry rolls or sheets as well. Nevertheless, in the case of market pulp, there is no detachment action for adhesives, ink particles and additives however, repulping with LHR for the defibration of crystalline cellulose is essential. Principally, the invention increases the fiber recyclability life span and hence it is focused on waste paper where the fiber recyclability is often necessary.

Market pulp is mostly produced from long fiber softwood tree species. Nonetheless, hardwoods are also used in the production of market pulp. For the production of market pulp, the lignocellulosic material is sourced from sawmill residuals and deficient logs. The pulping process for market pulp production can be a chemical (i.e., sulfate, sulfite) or mechanical one such as chemi-thermo-mechanical. However, sulfate (i.e., kraft) pulping process currently predominates worldwide. In this process the wood chips are chemically cooked in a digester to separate primarily cellulose (fibers) from lignin Consequently, market pulp is a high quality pulp used often to make strong and durable paper products. Market pulp is also mixed with secondary fibers as in the case of recycled paper industry to improve the strength and physical properties of finished paper products.

Effect of Repulping Medium on Cellulose (Amorphous and Crystalline Celluloses):

Fiber hornification is the major drawback of the current conventional technology which is incapable of alleviating it in the recycled paper industry, i.e., greater fiber losses, low productivity, inferior fiber quality, excessive chemicals use, more water and energy consumptions.

This is attributed to the hydrophilic/hydrophobic nature of cellulose and its structural arrangement, (i.e., native cellulose) chains are arranged in a parallel manner and organized in sheets stabilized by interchain OH—O hydrogen bonds. The stacking of cellulose sheets is stabilized by both van der Waals (vdW) and H-bonds. Besides the hydrogen bonding, cellulose has van der Waals dispersion forces and electrostatic interactions, however, the two latter forces are of less influence compared to that of the H-bonds. In this respect, cellulose is a preponderant hydroxyl functional groups polymer, and hence it reacts with many polar solvents including water.

In this context, in any chemical reaction the accessibility of cellulose to the reagent is highly important in the process of modification. The basis for obtaining any derivative or compound requires the effective contact of the reactants with each other. In the case of cellulose, this course is not easy because of its biphasic structure, i.e., amorphous and crystalline domains. In crystalline cellulose H-bonds between the cellulose molecules are not arranged in a random manner, but a regular pattern of hydrogen bonds that results in an order system with crystal-like properties.

Thus, the conventional repulping technology (i.e., neutral and alkaline) for recycled paper which has been a subject to many technological processes including drying, is an inappropriate technology because it influences only the amorphous cellulose. In other words, paper industry grade water or weak alkali repulping mediums (i.e., they produce directional type of swelling) can only influence/restore the H-bonding in the amorphous region leaving the crystalline cellulose mostly intact. Operations such as bleaching, wet end chemistry and drying are to substantially contribute to modification of fibers, i.e., they give rise to stresses and deformation of fiber hydrogen bonding and render hornified fibrous material. The aim of this invention is to eliminate all the short comings of the conventional technologies.

All elements of the invention will now be introduced by reference to figures, and then how each element functions and interacts with each other element will be described in detail.

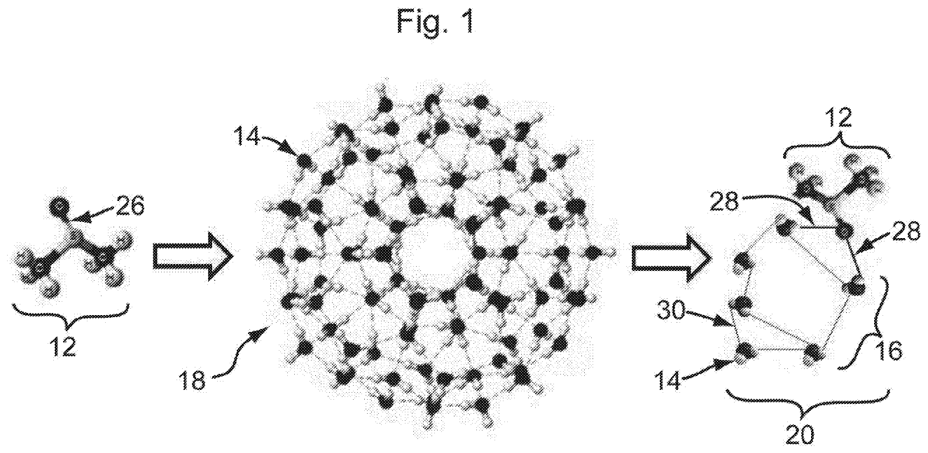

FIG. 1 shows a DMSO molecule 12 [a dipolar aprotic solvent (DMSO)(CH3)2] stripping a 6-water molecule segment 16 from a large water molecule cluster 18 and bonding to produce a LHR molecule 20. Water molecules 14 combine to form a 6-molecule segment 16 by means of attenuated hydrogen bonds 30. This segment 16 combines with the DMSO molecule 12 with two strong hydrogen bonds 28. Covalent bonds 26 of the DMSO molecule 12 are also illustrated.

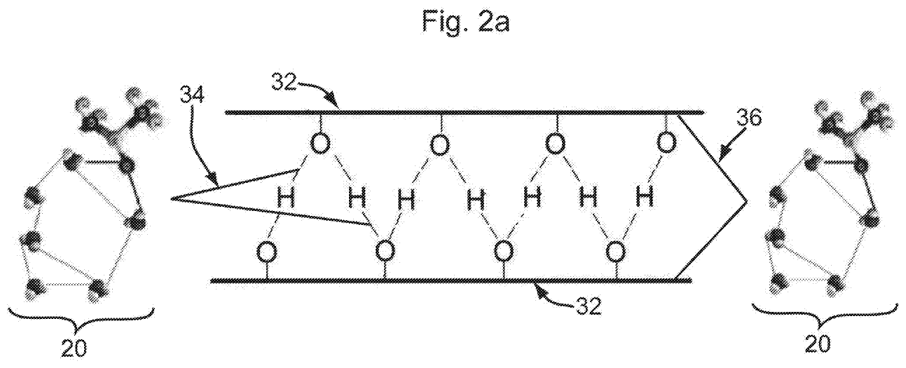

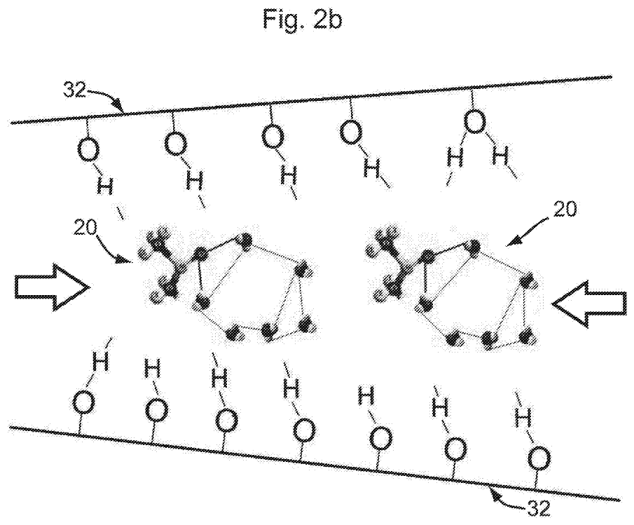

FIG. 2a shows where LHR molecules 20 target the inter-molecular H-bonds 34 and intra-molecular H-bonds 36 of cellulose molecules 32 in repulpable material. FIG. 2b shows the effect of LHR molecules 20 on the H-bonds (34 & 36) of cellulose fibers 32.

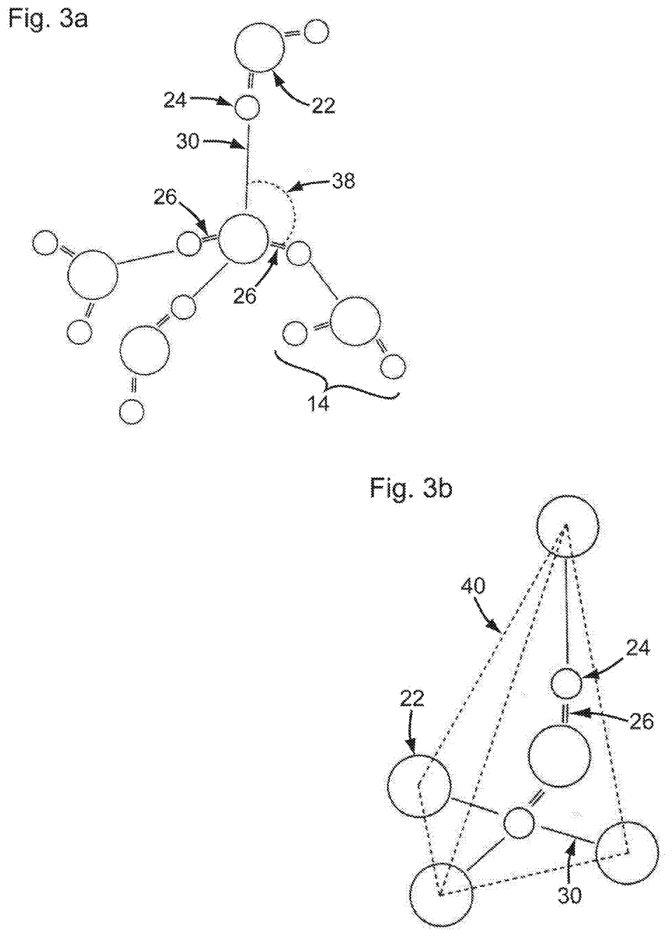

FIG. 3a shows how an H-bond angle 38 is stretched from 104.51 degrees to 109.47 degrees as a result of the influence of LHR. FIG. 3b shows an angle/3D outline 40 tetrahedral form caused by the influence of LHR.

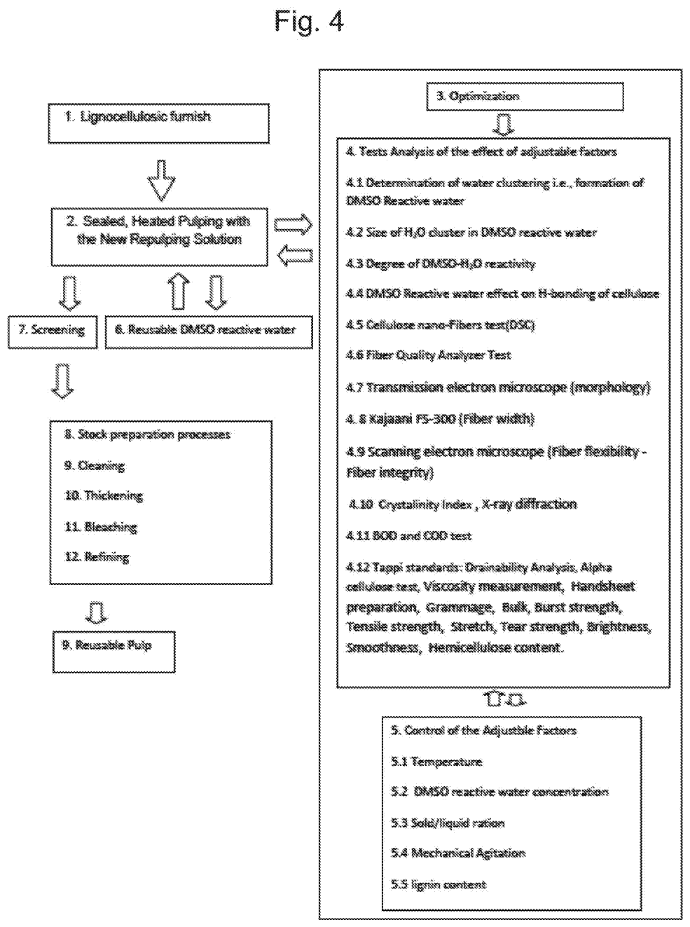

FIG. 4 is a block diagram outlining the steps of the effective repulping method of this invention. These steps are described in more detail in the description of the Preferred Embodiment below.

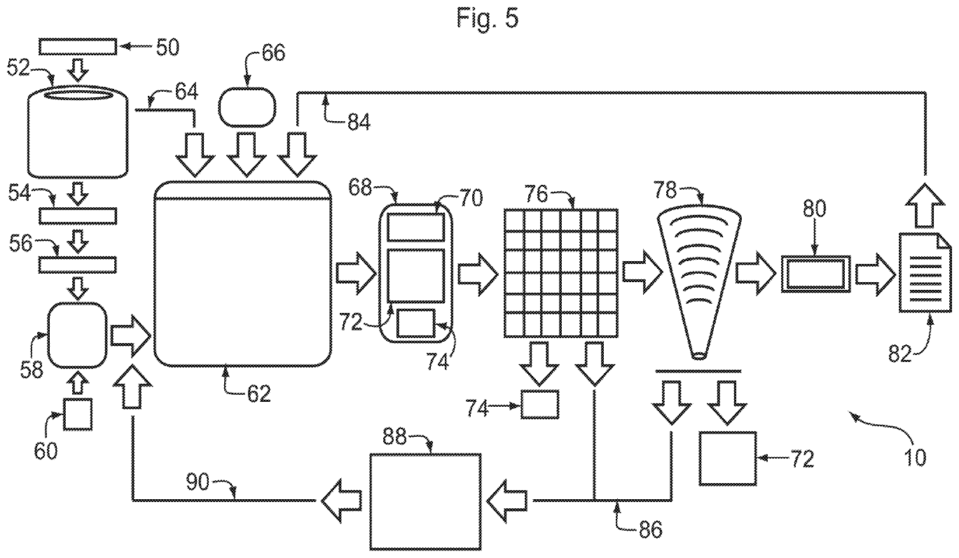

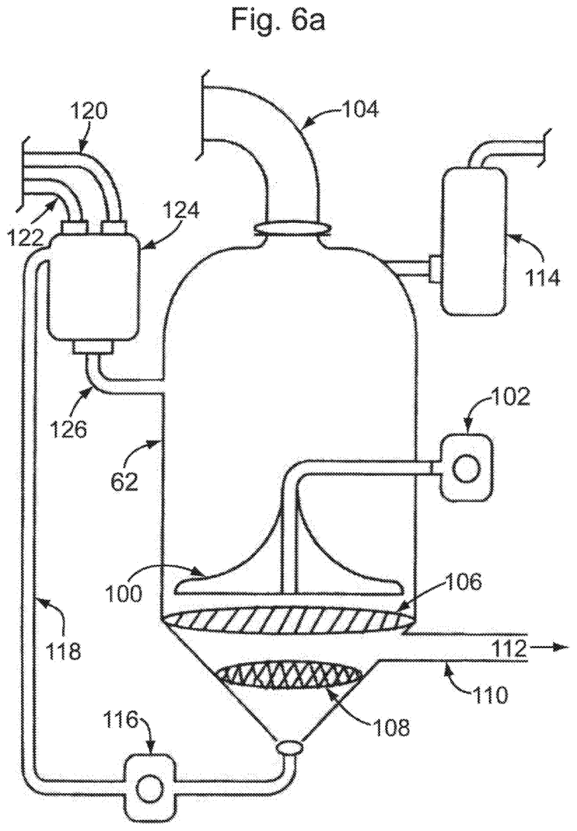

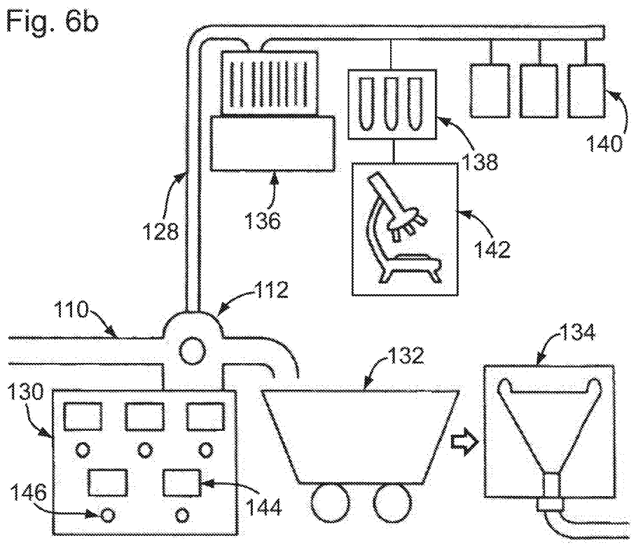

FIG. 5 illustrates the processes of the disclosed effective repulping method 10. Wood 50 is processed in a digester 52, converting it to wood pulp 64, and is combined with market pulp 66 and recycled paper furnish 84 into a hydropulper 62. (see FIG. 6 for more detail) Lignin 54 from the digester 52 also generates DMSO 56, which dissolves water 60 (see FIG. 1) to create LHR 58 which is injected into the hydropulper 62 and mixed with the pulp materials to significantly enhance the extraction of cellulose fibers 32. (see FIGS. 2a & b) The resulting treated pulp 68 is comprised of fibers 70, unwanted elements (inks, additives, adhesives) and non-fibrous material 74. Screening 76 extracts non-fibrous material 74, while cleaning 78 extracts the unwanted elements 72. Both processes generate waste/reactive water 86 which is treated in a bioreactor 88 generating treated reactive water 90 which is recycled into the hydropulper 62. The result of the treating, screening & cleaning process is restored fibers 80 that can be used to produce high quality recycled paper products 82 such as graphics, sanitation, packaging, newsprint, specialty papers & market pulp.

FIG. 6a is a diagram showing the hydropulper 62 (a batch open vat pulper, allowing observation of the process) with its agitator 100 and motor 102. The pulping process starts with recycled paper (e.g., mixed office waste (MOW)). The coarse filter 106 allows the re-pulped material to fall through, where is drawn off by outlet pipe 110 by means of a suction pump 112. (see FIG. 6b) The fine screen 108 allows the solution to be drawn off through a solvent outlet pipe 118 by means of a solvent suction pump 116, by which it is recycled to the solvent storage tank 124. The dipolar aprotic protophylic solvent inlet pipe 122 supplies the solvent to the solvent storage tank 124, and a water inlet pipe 120 allows for a dilution of the LHR solution. The repulpable material is supplied via inlet chute 104, while the solvent is supplied from the solvent outlet pipe 126. Heat can be supplied by steam boiler 114, taking into account its effect on the concentration of the solution.

FIG. 6b is a continuation of FIG. 6a as they are connected by the outlet pipe 110. FIG. 6b illustrates some of the control, testing and optimization apparatus used in this invention. The optimization process involves fibre samples collected from a sample outlet 128 subjected to an infrared spectrometer 136, preparation in accordance with the selected tests as noted below in test tubes 138 for analysis under a microscope 142, preparation of test sheets 140 for the handsheet tests noted below, all sending feedback to the Factor Control Panel 130. The panel 130 monitors 144 and adjusts 146 the following parameters: temperature, LHR solution concentration, type of recycled lignocellulosic material, solid/liquid ratio, and the degree/duration of the mechanical agitation. The re-pulped material is dumped into hopper 132 for transport to washing facilities, using a conical centrifuge washer 134, for example.

The preferred embodiment of the invention will now be described in detail.

This invention provides a new method of efficient repulping using LHR/improved water in an agitator vat, or pulper, with optimization of process variables depending on the reactivity of LHR quality, type of material being re-pulped and the desired characteristics of the pulp resulting from the process. The mechanism of lignocellulosic materials repulping in LHR is based on physical reactions of the LHR, first with water from one part of the solvent and second LHR with cellulosic material from the other part of the solvent.

The first physical reaction is caused by the substantial alteration of water structure through the rearrangement of its hydrogen bonding system within the LHR molecules. Consequently, due to the simulation analysis, the DMSO is bonded to two water molecules, and the average angle between the two hydrogen bonds in the aprotic solvent·2H₂O (i.e., DMSO·2H₂O) is almost tetrahedral.

The second physical reaction may be attributable to the greater accessibility of cellulose as a result of disruption/destruction of hydrogen bonding by the LHR in both amorphous and crystalline zones. The second physical reaction is the hydration of both cellulose and hemicellulose by chemical and mechanical actions of the treatment. Furthermore, since the LHR has an enhanced hydrogen bond acceptor and has a high solvating power, this technique will ease and lead to a total detachment of ink, additives and adhesives from the fibers.

The process is characterized by:

LHR has superior qualities: high dissolving power, low surface tension, greater carrying efficacy, increased microbiological stability. In addition, it is characterized by ice-like water molecule clusters (i.e., 6-water molecule clusters) which have a direct influence on H-bonding system (intra- and intermolecular) of the cellulose micelle crystallites, and hence intramicellar (dimensional) swelling can be insured.

H-bond disruption/destruction by the LHR (i.e., DMSO micro-clustered water with attenuated H-bonds) is to offer accessible cellulose with open H-bond packing.

The process of LHR creates water molecules with weaker hydrogen bonds and smaller water clusters (i.e., micro-clustered water) that can easily interact with cellulosic material and bring about considerable hydration within it. As a result, several benefits can be attained including better fibrous material hydration power, increased quality detachment of adhesives, additives, and ink particles, enhanced microbiological stability, improved pulp mixing quality, greater inter-fiber bonding capacity and minimum use of chemicals including sheet strength and sizing agents.

In a similar manner, the process ensures a concerted disruption/destruction of hydrogen bonding of the cellulose (carbohydrate) by LHR and minimizes the removal of hemicellulose by avoiding neutral and alkaline treatments. This is achieved by penetration of LHR into the cellulose (amorphous and crystalline), and interaction of dipolar solvent structured water molecules (i.e., with attenuated H-bonds) with cellulose (carbohydrate) molecules through their hydroxyl groups. This presumably brings about stereo-chemical changes (i.e., rotational) that disrupt and permanently weaken the H-bond of both amorphous and crystalline cellulose, thereby providing accessible cellulose. Collateral benefits include recovered fibers with open H-bond packing that can be continuously recyclable unless subjected to modification (i.e., fiber shortening as in tissue manufacturing), clean non-fibrous rejects, minimum removal of hemicellulose, uniform defibration of the cellulosic material, greater fiber integrity, better interfiber bonding, easy detachment of additives, adhesives and ink particles, and ease of bleaching.

For optimum results, the temperature, LHR concentration, consistency, pulping time and mechanical agitation (the “Adjustable Factors”) should be adjusted in accordance with known experimental data and test effects of those factors on the type of lignocellulosic product to be pulped: market pulp, pre-consumer paper, mixed office waste (MOW), old newsprint (ONP), paperboard, old corrugated containers (OCC), paper liners, packaging paper boxes, coated and uncoated papers, mixed papers, old magazines (OMG), and like products.

The temperature of the repulping solution should be in the range of 5 to 90° C., with a range of 5 to 40° C. often producing optimal results for a typical mix of recyclable papers. The concentration of LHR should be in the range of 0.001% to 40%. For optimal result of a typical mix of recyclable lignocellulosic products the often concentration of LHR is within the range of 0.1% to 3%. The solid/liquid consistency should be in the range of 1% to 33% by weight, however, the usual consistency is in the range of 1% to 15%. The mechanical agitation of the repulpable material should be in the normal range of the equipment used for agitation and mixing in repulping processes. The time of the mixing should be in the range of 1 to 90 minutes.

The LHR influence on water molecule structure occurs through the alteration of the hydrogen bonding lattice; weaker hydrogen bonds can be examined using IR absorption spectroscopy, differential scanning colorimeter (DSC) this can examine the 6-water molecule clusters of the dipolar aprotic solvent LHR, i.e. the spectrum of this technique is expected to demonstrate two bands, one for the disordered water and the other for 6-water molecule clusters of LHR (i.e., more ordered water). For water cluster size can be studied using Mass Spectrometric analysis of dipolar aprotic solvent-water binary. Microbiological stability of LHR repulping solution can be examined through determination of chemical oxygen demand (COD) and biological oxygen demand (BOD).

The effect of varying these parameters (temperature, LHR solution concentration, consistency and furnish type) on pulp quantity and quality can be assessed by fiber quality analyzer (FQA), transmission electron microscope (TEM), Kajaani FS-300, sugar analysis, alpha cellulose content, scanning electron microscope (SEM), X-ray diffraction (XRD), drainability analysis and Tappi standards.

The novel application of new repulping solution, i.e., LHR in pulping of recycled paper is designed to address the major problem of conventional neutral and weak alkali (1% NaOH) swelling which takes place mainly in the amorphous zone of the cellulose. Also, it is a directional and H-bond reversible swelling. In other words, conventional swelling has no effect on the crystalline cellulose, i.e., H-bonds in the crystalline cellulose remain mostly intact. Thus, this is the reason for recycled paper industry having a poor product with inferior fiber quality such as fiber stiffness, fiber fatigue, fine generation and difficulty with ink, fillers and stickies removal. Additionally, the conventional technology responds to this problem in a partial manner only by using, for swelling either water or 1% NaOH, for deinking fatty acids and surfactants, for buffering sodium silicate, for strength properties enhancement starch and other synthetic polymers.

However, the present solution for the root cause (hornification) for the shortcomings of recycled paper conventional pulping lies in the application of LHR repulping, because in one part the new repulping solution (i.e., LHR) is made up of excellent swelling agent with high degree of penetrability, plasticity, reactivity and strong H-bond acceptor characteristic. These properties make the new repulping solution capable of influencing H-bonds in both water and cellulose (i.e., amorphous and crystalline) and offering LHR with superior qualities and cellulose with flexible fibers and open H-bond packing. In other part, LHR, (i.e., 6-water molecule clusters coupled with attenuated H-bond water molecules) with its superior qualities; increased dissolving power, lower surface tension, high carrying efficacy and greater microbiological stability, plays a major role in securing unique swelling that to substantially affect both amorphous and crystalline zones of the cellulose. This type of swelling, that influences internal and external H-bonding system of cellulose micelle crystallites (i.e., cellulose nano-fibers), is termed “intramicellar swelling”. This phenomenon of swelling cannot be achieved using neutral or weak alkali concentration. In LHR repulping flexibility of fibers, opening of H-bonding, detachment of ink, fillers and stickies proceed at the same time as the pulping takes place.

Also, LHR repulping is ideal in environmental and economic sustainability sense because is a direct replacement of all chemicals used in conventional neutral and alkaline methods that provide equal or higher quality, yield and efficiency at a fairly lower cost. Of course, such statements need further research and verification.

As a remedy for conventional neutral and alkaline repulping the application of LHR represents a practical and effective technology for a sustainable business in pulp and paper industry. On the one hand, the LHR repulping will considerably contribute to multifold benefits including increase of productivity, enhancement of strength and physical properties of paper finished products, reduction of water and energy consumptions. On the other hand, the application of LHR in recycled paper manufacturing sector will be environmentally friendly and contribute to reduction of carbon foot print, greenhouse gas emissions, less sludge, and hence lower COD and BOD. In this respect, the proposed technique is suitable to treat all types of recycled lignocellulosic products, each at certain optimum conditions. Further on, in the proposed technique, the recovery of LHR is taken into account.

The process is flexible enough to accommodate any of oxidizing, reducing, deinking, dispersing, chelating, buffering, filling, strength enhancing, detackifying agents if needed. However, LHR repulping alone is capable of offering high yield and superior fiber quality for all types of recycled lignocellulosic products.

Dimethylsulfoxide (DMSO) Chemistry:

Industrially, dimethylsulfoxide (DMSO) is a lignin derived compound. It is a commercially manufactured, as a dipolar aprotic solvent, from lignin which is the main by-product of wood pulping. On the other hand, DMSO seems to be a part of earth's complex sulfur cycle as it is naturally occurring substance. DMSO is found in natural waters, soil, and food products such as tomato paste, milk, sauerkraut, tea, coffee, beer and in some plants including corn and alfalfa.

DMSO has relatively thermal stability at its normal boiling point (189 degrees ° C.). The rate of thermal decomposition is less than 2% on 24 hour reflux at 189 degrees ° C. Also, under neutral or basic conditions DMSO is fairly stable below 150 degrees ° C. Accordingly, pure DMSO is essentially odorless. As of DMSO has the largest dielectric constant (48.9) of the common dipolar aprotic solvents. In addition, another understated phenomenon of DMSO is that its stereo-chemical solvating ability. For instance, the structure of the DMSO molecule is not flat like that of acetone which is one of the dipolar aprotic solvents family, i.e., DMSO molecule is mostly trigonal pyramidal in shape.

Consequently, DMSO has a high directional lone pair of electrons at the apex of the pyramid which helps, in reactions, solvate numerous complex and typical solute molecules. Hence, DMSO, as a reaction solvent, has shown advantages in many various reactions including etherification, addition, displacement, cyclization, condensation, isomerization, elimination, polymerization and solvolysis. It is of significance to note that as DMSO is very miscible with water, thoroughgoing cleanup of various chemical reactions using water or aqueous detergent is a great benefit.

Also, DMSO is recognized as the most powerful organic solvent available in the market. This characteristic is due to its capacity to dissolve huge variety of substances that cannot be dissolved by other organic solvents. As of DMSO multiple advantages and greatest solvent power, it has emerged an early solvent choice in the design of numerous chemical processes. DMSO is capable of dissolving a remarkable number of organic molecules, carbohydrates, polymers, and many inorganic salts and gases. Thus, cost-effective “one-pot” reactions are not uncommon features of DMSO chemistry.

In this invention to manufacture the repulping solution, i. e., LHR/improved water DMSO has been found as the most ideal one among all dipolar aprotic solvents. The unique presence of the Sulfur element in DMSO molecule and all chemical pulping solutions could be understood as the most effective agent for cellulosic fiber separation in both pulping and repulping processes. The aim of the interaction of DMSO as hydrogen bond acceptor (HBA) with water as hydrogen bond donor (HBD) is to bring about stereo-chemical changes (rotational) within the water H-bonding system and offer oxygen-rich micro-clustered water characterized with small water molecule clusters (e.g., 6-water molecule clusters).

Concerning toxicity of DMSO, no individual has ever been harmed by routine, or accidental contact with DMSO. DMSO is the only dipolar aprotic solvent rated “3”, i.e., the safest solvent for pharmaceutical applications by the International Conference for Harmonization (ICH). With regards to acute toxicity of DMSO, it has fairly low acute and chronic toxicity for plant, animal and aquatic life. Additionally, DMSO exposure to test organisms at high concentrations by contact, inhalation or ingestion consistently has proven low toxicity, and hence, DMSO is not listed as a carcinogenic or mutagenic. Furthermore, DMSO is not teratogen in rats, mice and rabbits. Thus, the Environmental Protection Agency (EPA) has approved DMSO as a solvent in pesticides which are used before crop emergence or prior to the development of edible parts of food plants. DMSO has found wide applications in many industrial sectors including pharmaceutical, petrochemical, agrichemical, coatings, printing inks, paints, semiconductors.

Chemistry of DMSO and Water:

It is known that low concentration of some solvents such as dipolar aprotic solvents bring about stereo-chemical changes and modify the water structure in such a manner that suppresses the protic characteristic (H bond donor—HBD) of water and enhances its basic (H bond acceptor—HBA) reactivity one. Thus, DMSO as a dipolar aprotic protophilic is capable of arranging water structure through influencing its H-bonding system and rendering water with superior characteristics.

Water-dipolar aprotic solvent binary system is a powerful solvent system used frequently in many branches of chemistry and industries, and their efficient application in chemical processes will contribute to reduce a global environmental impact. Solvent effects in these systems depend nonlinearly on the mixing ratio, and studies of preferential solvation have offered important results.

Water is a fairly malleable substance. Its physical shape easily adapts to whatever environment is present. However, its physical appearance is not the only thing that changes, but the molecular shape is also susceptible to change as well. The energy or vibrations of the environment has a quite effect on changing the molecular shape of the water. In this sense water not only has the ability to visually reflect the environment but it also molecularly reflects the environment.

The reactivity changes within the water structure are well responsible for rendering water with unique qualities such as ice-like, highly structured small water molecule clusters, increased dissolving power (i.e., dissolution of extraneous substances such as stickies, minerals and ink), lower surface tension, better microbiological stability and greater self-purification capacity. Additionally, the LHR is fairly effective OH free radical scavenging agent. The LHR is highly structured with smaller clusters of six water molecules. These predominating ice-like clusters of water are believed to represent the highly structured part of liquid water.

Accordingly, the angle between the two hydrogen atoms, bond in the LHR molecule (i.e., DMSO·2H₂O), is nearly tetrahedral. In other words, the rearrangement of hydrogen bonding within the LHR produces weaker hydrogen bonds between water-water molecules than those produced between DMSO and water molecules. These water molecules with weak hydrogen bonds are ready to interact through intra- and intermolecular hydrogen bonding with the sugar units and produce substantial hydration within the cellulosic material. Also, the predominance of smaller water clusters in LHR systems will give rise to increased weakened hydrogen bonds between the micro-clusters themselves. Similarly, these small clusters would contribute to better impregnation and hydration throughout the fibrous material (i.e., amorphous and crystalline cellulose), which are essential for detachment of adhesives, additives, ink particles, interfiber bonding and uniform defibration.

The Role of LHR in Repulping:

This technology is designed to afford a uniform defibration within the lignocellulosic material. In other words, LHR has a significant effect on the crystalline cellulose, i.e., this type of repulping using LHR gives rise to break down of H-bonds within both the amorphous and crystalline zones of the cellulosic material, and hence render cellulose with flexible fibers and open H-bond packing. This is because LHR under optimum conditions is capable of securing unique type of swelling termed “intramicellar swelling” that not only affects the H-bonding of amorphous but also the one of crystalline cellulose, i.e., the H-bonding within the cellulose micelle crystallites. Factors influence repulping optimization including type of pulp (degree of H-bonding exposure, i.e., LCC level), LHR concentration, consistency, mechanical action of pulper, the reaction time and temperature. Thus, in LHR repulping, flexibility of fibers, opening of H-bonding, detachment of ink, additives and adhesives proceed at the same time as the repulping takes place.

LHR repulping is also ideal in an economic sense because it is a direct replacement of all the chemicals used in conventional repulping methods (neutral and alkaline methods) that provides equal or higher quality, yield and efficiency at a lower chemical cost.

In this context, through intramicellar swelling LHR repulping is capable of rendering flexible and conformable cellulose with minimum stress and deformation. This quality cellulose, using nano-fiber analysis, can be demonstrated in enhanced average fiber weighted length, higher coarseness, lower curl and kink indices and fairly high percentage of side branching of microfibrils (i.e., <0.2 mm). In reality, these acquired properties should lead to production sustainability; clean non-fibrous rejects, increased productivity, substantial hemicellulose retention, better strength and physical characteristics, magnificent sheet formation, less water and energy consumptions.

Reclamation of LHR:

Lately, membrane bioreactor (MBR) technology has gained much popularity in treatment of paper industry wastewater. MBR integrates conventional bio-treatment and membrane filtration. Additionally, MBR technology allows high sludge age, low hydraulic retention time (HRT) and a higher biomass concentration than that of the conventional activated sludge (CAS) technology. Subsequent advantages of MBR compared to conventional wastewater treatment technology include permit of high biomass concentration, greater degree of organic matter removal, low foot print, i.e., space saving, the possibility of reduced sludge production, possible recyclability of effluent in case of required quality not attained, and powerful efficiency of reusable industrial water recovery. Disadvantages of MBR include membrane fouling, trained technical personnel and high energy consumption.

In LHR situation, these unfavorable conditions (i.e., membrane fouling and high energy consumption) are unlikely to occur. This is because the repulping method of this invention is designed to offer effective separation and removal of additives, ink and adhesives and at the same time to secure uniform defibration within the amorphous and crystalline cellulose (i.e., 0% fiber rejects).

The aim of MBR application is to recover high quality effluent, i.e., reusable LHR. Recycled paper industry wastewater represents a vital environmental and economic problem. The wastewater from recycled paper industry is usually characterized by excessive quantities of chemical oxygen demand (COD), biological oxygen demand (BOD), color, pH, suspended solids (SS), dissolved solids (DS), and dissolved oxygen (DO). However, in this invention, pure recovered LHR with its small water molecule clusters (6-water molecule clusters) and water crystallization will be secured.

Some additional advantages of using the disclosed invention over other methods or devices will now be described.

LHR—Quality and Advantages:

Dipolar aprotic solvents improve the water quality by organizing its internal structure. In other words, DMSO interaction with water physically enhances the quality of water for the pulp and paper industry in many different ways. For example, in paper industry where huge amounts of water are consumed (i.e., in most cases over 100 m3 of water/ton of fibers (dry weight), this, through rearrangement of hydrogen bonding of water, offers a LHR which is of importance for water consuming pulp and paper industry.

The aim of alteration water structure is to increase its reactivity. This can be achieved through the interaction of DMSO with water; the hydrogen bonding of water is stereo-chemically rearranged in a way that the water molecules acquire almost their natural conformation, i.e., tetrahedral lattice. For instance, when DMSO is added to the water, the water molecules are assumed to regain more OH stretch, through the stereo-chemical changes (i.e., rotational) brought about by the interaction of DMSO with H-bonding system of water molecules that could approach the natural H—O—H angle which is 109.47°.

As a result, the LHR acquires several positive properties such as smaller water molecule clusters and water with attenuated H-bonds (i.e., 6-water molecule clusters and ice crystal-like water molecules), lower surface tension, better carrying efficiency, increased hydration capacity, improved power of microbiological stability (i.e., the rearrangement of hydrogen bonding through DMSO is to render a water structure of almost with appreciable oxygen which is a favorable environment for bacteria and enzymes growth) and greater interfiber bonding power.

Consequently, LHR secures aerobic environment for microorganisms to consume considerable amount of contaminants of wastewater, and hence the COD or BOD will be substantially lower than those of the conventional ones. Additionally, the improved microbiological stability of LHR would not only maintain good levels of reduction in biochemical oxygen demand (BOD) and total suspended solids (TSS), but also the reduction of these parameters is expected to go faster than as it proceeds in the conventional method.

These results can be attributed to the following explanations; 1—the LHR (i.e., 6-water molecule clusters and ice-like water molecules), developed through the interaction of DMSO with water H-bonding system, becomes more oxygen rich, and hence this condition will give rise to a favorable environment for microorganisms to actively consume and metabolize suspended organic contaminants (TSS) in the DMSO repulping generated wastewater, 2—and/or LHR repulping method offers wastewater with minimum amount of generated fines (i.e., less suspended organic matter (TSS)), 3—and/or the LHR repulping process yields wastewater with fairly low levels of total dissolved solids (TDS)—efficient additives separation and removal.

These LHR qualities are essential for various pulp and paper technological processes where highly purified “reactive” water (i.e., small water molecule clusters and water crystallization) is crucial. For repulping, pulp washing, screening, cleaning, soaking, mixing, fibrous material transportation, bleaching and refining, water is of significance since the main components (e.g., cellulose, lignin and hemicellulose) of the fibers are all biodegradable and hence this quality of the LHR will limit the bacteria and fungi growth in the process water. Thus, the dipolar aprotic (DMSO) hydrogen bond rearranged water offers the following advantages:
(1) Attainment of uniform defibration within both amorphous and crystalline zones of cellulose due to the ability of the LHR (e.g., with highly structured 6-water molecule clusters) to impregnate and bring about irreversible changes within the H-bonding of both zones, whereas this phenomenon cannot be sustained particularly in the crystalline region using conventional neutral or alkaline repulping methods. This LHR is capable of securing swelling type termed “intramicellar swelling” which results not only in influencing the H-bonds of amorphous cellulose but also the supramolecular structure H-bonding of cellulose micelle crystallites and renders reactive cellulose with open H-bond packing.
(2) Increased fibrous material hydration capacity as a result of smaller water molecule clusters interaction and their easy impregnation within the cellulosic material, i.e., this is due to the high frequency and energy of LHR.
(3) LHR has a high efficient and selective removing capacity of adhesives, additives and ink particles within the amorphous and crystalline cellulose and this will give rise to liberation of fibers with integrity. This is due to its increased dissolving powers.
(4) LHR is efficient medium for mixing of fibrous material and will lead to appreciable swelling of the fibers. This is because low surface tension is one characteristic of LHR superior qualities.
(5) LHR maintains substantial fibrous mass transfer. This is due to its high dissolving quality and greater carrying efficacy.
(6) LHR offers minimum sludge. This is because of its ability to secure repulping with effective separation and removal of additives, ink particles and adhesives and almost no hornification (i.e., 0% pulp rejects) upon optimum conditions.
(7) Limited use of biocides. This trend can be attributed to the aerobic environment secured by LHR which one of its unique characteristics is microbiological stability.
(8) LHR secures favorable environment for microorganisms to consume and metabolize organic matter. This is because LHR is oxygen-rich water which provides aerobic settings for organic contaminants consumption by microorganism. As a result, lower levels of COD and BOD can be attained.
(9) LHR insures better hemicellulose retention. This is because LHR repulping method is based on a physical reaction between the H-bonding of the LHR and the hydroxyl groups of the cellulose and hemicellulose, i.e., intra- and intermolecular H-bonding of the carbohydrate.
(10) LHR secures easy and effective dissolution, removal, screening and cleaning of contaminants from the fibrous material and the reduction in water consumption will be attained. This is due to the superior qualities structured water.
(11) LHR will cut down in energy and chemical consumptions due to easy execution of the following technological processes; pulping, screening, cleaning, soaking, mixing, bleaching, refining, sizing and sheet formation, i.e., greater production sustainability and safe environment can be attained using LHR rather than the use of many chemicals as in the conventional neutral and alkaline repulping methods.
(12) LHR can be reclaimed from wastewater for reuse.

In this context, from the sustainability point of view, through the new repulping solution (i.e., LHR) of recycled lignocellulosic products the following substantial economic benefits can be realized:
Increase in productivity
Enhanced sheet strength and physical properties
Burst index
Tensile index
Tear factor
Stretch
Brightness
Smoothness
Less pulping time
Zero fiber rejects
Reduction in energy consumption
Reduction in water consumption
Substantial cut down in virgin pulp use
Less chemicals use
Low maintenance frequency
Lowered production costs

With respect to environmental impact, through new repulping solution (i.e., LHR) of recycled paper the following benefits can be achieved:
Less sludge
No anti-climate change emissions
Reduced COD
Low BOD
Lesser wastewater
Cut down in biocides use
Reduction in carbon footprint

The recovery and reuse of the process LHR makes further environmental and economic sense for pulp and paper industry. The well-designed recovery systems using the MBR can pay for themselves in a relatively short period.

Tests for Optimization of Repulping Process Variables:

For optimized repulping process, the following tests are to be applied in order to adjust the process variables:

(1) For determination of DMSO clustered water sophisticated investigative techniques are to be performed such as Far Infrared (FIR) vibration-rotation-tunneling (VRT) spectroscopy (an infrared spectroscopy (IR)).

(2) The LHR influence on the alteration of the hydrogen bonding lattice and the weakened hydrogen bonds can be examined using IR absorption spectroscopy—diffuse reflectance infrared fourier transformer (DRIFT) for the (OH) stretch.

(3) Differential scanning colorimetry (DSC)—Perkin Elmer differential scanning colorimeter DSC-1B equipped with cooling cells will be used to examine the efficiency of the LHR, i.e. the spectrum of this technique should demonstrate two bands, one band for the disordered water and the second band for LHR, i.e., 6-water molecule clusters. The ice-like clusters of water are to represent the highly structured part of liquid water.

(4) For LHR cluster size (i.e., 6-water molecule clusters formation with DMSO can be studied by doping argon gas clusters in an aprotic solvent untreated water pick-up cell, and the subsequent electron impact ionization of the doped clusters for each solvent using gas chromatography-mass spectrometer (GC-MS) analysis.

(5) ORP sensor: the oxidation-reduction potential sensor. It is a measure of the cleanliness of the water in millivolts “mV” and its capacity to break down contaminants.

(6) Dissolved Oxygen Measurement. The concentration of the dissolved oxygen in water is measured using dissolved oxygen sensor and meter.

(7) For BOD measurement, nutrients, microorganisms are added to the wastewater to be tested, and is then incubated. After five (BODS) days, the used amount of oxygen in the already pulped LHR solution is measured and biodegradable organic matter content is calculated.

(8) For COD parameter test, the wastewater sample can be chemically oxidized and the used amount of oxygen is measured.

(9) pH test: the pH-meter will be used for the determination of the basicity of the repulping solution.

(10) DMSO concentration sensor will be applied in order to measure the concentration of the DMSO in the new repulping solution (i.e., LHR).

(11) The water hardness of dipolar aprotic solvent LHR can be tested using total dissolved solids (TDS) analysis.

(12) For color and turbidity measurements of LHR the total suspended solids (TSS) can be performed on nephelometer. Turbidity is measured in nephelometric turbidity units (NTU).

(13) Drainability test can be measured by the Canadian Standard Freeness (CSF). The result of this test is also directly proportional to the H-bond disruption in the repulpable material. Drainability test can also be a measure for the changes that may have taken place during the repulping with LHR, i.e. presence of the crystalline cellulose long fibers, better defibration and fiber flexibility.

(14) The effect of varying repulping parameters (temperature, LHR concentration, and liquor/solid ratio) on pulp quantity, quality and water reactivity can be assessed through cellulose nano-fiber investigation by fiber quality analyzer (FQA), transmission electron microscope (TEM), Kajaani FS-300, sugar analysis, alpha cellulose content, scanning electron microscope (SEM), X-ray diffraction (XRD) and drainability analysis.

(14.1) Fiber Quality Analyzer parameters (i.e., Weighted average fiber length by length; Weighted average fiber length by weight; Coarseness; Curl index; Kink) determine the influence of LHR on intra- and inter-molecular H-bond of the cellulose. On the other hand, the percentage of side branching fines (i.e., percent fines <0.2 mm (%) and percent fines <0.2 mm weighted length) is a direct proof of the intact fiber recovery and flexibility.

(14.2) Kajaani FS-300 determines the percentage change in nano-fiber which shows the effect of the LHR on the intra-molecular hydrogen bonding and the improvement of the fiber hydration capacity.

(14.3) Transmission electron microscope (TEM) measures cellulose nano-fibers (CNFs), fiber width and fiber length.

(14.4) Scanning electron microscope (SEM) images for morphology of fiber integrity and side branching test.

(14.5) X-ray diffraction (XRD) analysis will illustrate the change in crystallinity index of LHR repulped lignocellulosic product due to defibration of the crystalline region of cellulose.

(15) Different standards and Tappi standard techniques such as kappa number, holocellulose content, alpha cellulose content, hemicellulose content, viscosity measurement, handsheet preparation, grammage, bulk, brightness, opacity, smoothness, burst strength, tensile strength, stretch and tear index should be employed to evaluate optimization of the recovered pulp, in order to optimize the process for any given type of repulpable material.

(16) Automated control unit to monitor the technological process variables including LHR concentration, lignin content, solid: liquid ratio, temperature and mechanical action of the agitator.

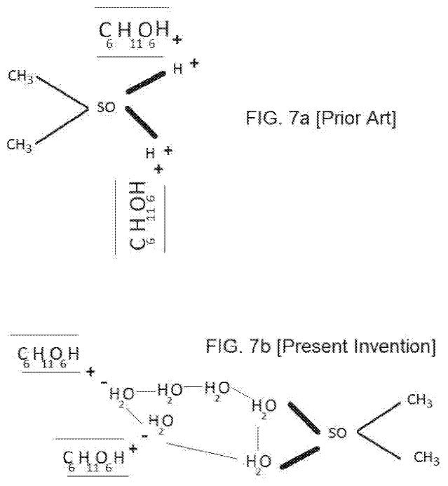

Referring to FIG. 7a, the chemistry of prior re-pulping methods using DMSO is shown, where hydroxyl groups (OH) of the cellulose molecules C₆ H₁₁ O₆ H⁺ act with less affinity toward the two water molecules with strong H-bonds (H⁺) associated with (CH₃)₂SO and result in fairly uniform defribation but not in de-hornification, whereas, referring to FIG. 7b, complete dehornification can be achieved using repulping optimization and the LHR method of the present invention, as the hydroxyl groups (OH) of the cellulose molecules C₆ H₁₁ O₆ H⁺ have greater affinity and act with no repulsion toward the attenuated H-bonds (H⁻) of water molecules present in LHR micro-cluster molecule (CH₃)₂SO(H₂O)₆. FIG. 7b shows the chemistry of the current invention achieving complete dehornification using repulping optimization and LHR effective OH free radical scavenging agent structured with ice-like six water molecules clusters.

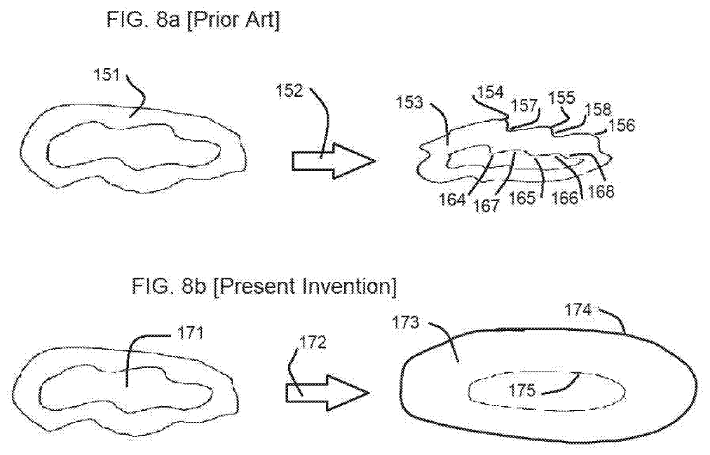

Referring to FIG. 8a, a cross-section 151 of lignocellulosic fiber before the conventional repulping process 152 becomes lignocellusic fiber after the prior art conventional repulping process as shown in the cross-section 153 with considerable hornification, that is, with structural protruding bumps 154, 155, 156 and folds 157, 158, for example, on its exterior, as well as a like multiplicity of bumps 164, 165, 166 and folds 167, 168 on its interior. In contrast, referring to FIG. 8b, a similar cross-section 171 of lignocellulosic fiber before the present invention LHR repulping process 172 becomes lignocellulosic fiber after the present invention LHR repulping process as shown in the cross-section 173 of repulped fiber, lacking the problematic hornification structures (of the cross-section 153 in FIG. 7a) and being overall more swollen and smoother on both exterior 174 and interior 175 of the LHR-repulped fiber.

Application of the new repulping solution in repulping of lignocellulosic products aims, to a greater extent, to limit the chances of fiber loss to the minimum (0% pulp rejects). In other words, the primary goal of the proposed project is focused on the attacking the root cause of fiber loss, i.e., which is the fiber hornification. The use of LHR in lignocellulosics repulping will enable a uniform defibration in both amorphous and crystalline zones of the substrate. Thus, LHR technique is capable of offering a high quality pulp that may approach the quality of virgin pulp. With this new repulping method it is realistic to expect less than 5% fiber loss during cleaning and washing operations, with a net pulp yield of 95%.

In the new repulping method of this invention, the breakdown of hydrogen bonding of the cellulose substrate (lignocellulosics) by the interaction of LHR that enables a minimal removal of hemicellulose (eg., surface adsorbed carbohydrate) compared to standard pre-existing repulping techniques. The advantages are immediate and allow for optimization as explained above. The higher process efficiency is expected to bring about significant impact on the economic feasibility and competitiveness of manufacturing of pulp from lignocellulosic products, producing high pulp yield and competitive fiber quality at less cost and involving fewer technological operations than conventional methods of repulping.

The within-described invention may be embodied in other specific forms, systems and methods and with additional options and accessories without departing from the spirit or essential characteristics thereof. The presently disclosed embodiment is therefore to be considered in all respects as illustrative and not restrictive, the scope of the invention being indicated by the appended claims rather than by the foregoing description, and all changes which come within the meaning and range of equivalence of the claims are therefore intended to be embraced therein.

1. A method of removing lignocellulosic hornification in repulping cellulose material, using lignin in a dipolar aprotic solvent to form a solvent for the cellulose material.

2. The method of claim 1, in which the lignin is a component of lignocellulose material.

3. The method of claim 1, in which a lignin derivative is placed along with the cellulose material to be re-pulped in an agitatorvat.

4. The method of claim 1, in which the dipolar aprotic solvent is a DMSO.

5. The method of claim 1, comprising optimization of process variables depending on a reactivity of a DMSO reactive water, a type of material being re-pulped and desired characteristics of the pulp resulting from the process.

6. The method of claim 1, in which a reactivity of a DMSO reactive water is measured firstly with water from a first part of the solvent and secondly with cellulosic material from a second part of the solvent;

7. The method of claim 6, in which the first part of the solvent is a lignin derivative and the second part of the solvent is DMSO reactive water.

8. The method of claim 1, comprising optimization of process variables depending on the quality of waste water resulting from the method.

9. The method of claim 1, comprising the steps of using DMSO molecules derived from lignin to form reactive water molecules that target and interact with inter-molecular H-bonds of cellulose molecules.

10. The method of claim 1, comprising the steps of:
a) processing wood in a digester, converting the wood to wood pulp;
b) combining the wood pulp with market pulp in a hydropulper;
c) injecting a DMSO reactive water formed from lignin from the digester into the hydropulper;

11. The method of claim 1, comprising the steps of optimizing at least one adjustable process factor from among the group of:
a) temperature of the mixture;
b) concentration of LHR in an aqueous solution;
c) liquid to solid ratio of the solution to the cellulose material;
d) mechanical action of the agitator;
e) duration of the agitation.
by testing the effect of varying such adjustable process factor on the resultant pulp for a given type of cellulose material against desired characteristics of the resultant pulp.

12. The method of claim 1, in which:
a) the temperature of the repulping solution is in the range of 5 to 90° C.;
b) the concentration of an LHR is in the range of 0.001% to 40% by volume;
c) the solid/liquid consistency is in the range of 1% to 33% by weight;
d) the time of the agitating and mixing is in the range of 1 to 90 minutes.

13. The method of claim 12, in which
a) the temperature of the repulping solution is in the range of 5 to 40° C.;
b) the concentration of an LHR is within the range of 0.1% to 3% by volume;
c) the solid/liquid consistency should be in the range of 1% to 15% by weight.

14. The method of claim 1, in which at least one of the following tests is applied to the resultant pulp and water to assist in the optimization of at least one adjustable factor:
a) Determination of water clustering (FIR, VRT, IR)
b) Size of H₂O cluster in LHR system (GC-MS)
c) Degree of LHR on H-bonding alteration (DRIFT)
d) Efficiency of LHR on H-bonding of cellulose (DSC)
e) Cellulose nano-Fibers test on resultant pulp
f) Verification of hornification removal (FQA)
g) Uniform fiber morphology with tendency to original form i.e. total removal of hornification
(TEM)
h) LHR repulping—fiber width increase (Kajaani FS-300)
i) Fiber flexibility and Fiber integrity (SEM)
j) Crystalinity Index, X-ray diffraction
h) BOD and COD tests
i) Tappi standards: Drainability Analysis, Alpha cellulose test, Viscosity measurement, Handsheet preparation, Grammage, Bulk, Burst strength, Tensile strength, Stretch, Tear strength, Brightness, Smoothness, Hemicellulose content.

15. The method of claim 1, in which at least one of the following adjustable factors is measured and controlled to assist in optimization of the method:
a) Type of recyclable lignocellulosic material (LCC level);
b) LHR concentration;
c) Repulping consistency;
d) Mechanical action of pulper;
e) Temperature;
f) Repulping time;
g) Strength and physical properties of the required end product.

16. The method of claim 2, in which:
a) a lignin derivative is placed along with the cellulose material to be re-pulped in an agitator vat.
b) the dipolar aprotic solvent is a DMSO;
c) process variables are optimized depending on a reactivity of a DMSO reactive water, a type of material being re-pulped and desired characteristics of the pulp resulting from the process;
d) the reactivity of the DMSO reactive water is measured firstly with water from a first part of the solvent and secondly with cellulosic material from a second part of the solvent;
e) the first part of the solvent is a lignin derivative and the second part of the solvent is DMSO reactive water;
f) DMSO molecules derived from lignin are used to form reactive water molecules that target and interact with inter-molecular H-bonds of cellulose molecules.

17. The method of claim 16, comprising the steps of processing wood in a digester, converting the wood to wood pulp, combining the wood pulp with market pulp in a hydropulper, injecting DMSO reactive water formed from lignin from the digester into the hydropulper, and optimizing at least one adjustable process factor from among the group of:
a) temperature of the mixture;
b) concentration of an LHR in an aqueous solution;
c) liquid to solid ratio of the solution to the cellulose material;
d) mechanical action of the agitator;
e) duration of the agitation.
by testing the effect of varying such adjustable process factor on the resultant pulp for a given
type of cellulose material against desired characteristics of the resultant pulp.

18. The method of claim 17, in which:
a) the temperature of the repulping solution is in the range of 5 to 40° C.;
b) the concentration of LHR is within the range of 0.1% to 3% by volume;
c) the solid/liquid consistency should be in the range of 1% to 15% by weight.
d) the time of the agitating and mixing is in the range of 1 to 90 minutes.

19. The method of claim 18, in which at least one of the following tests is applied to the
resultant pulp and water to assist in the optimization of at least one adjustable factor:
a) Determination of water clustering (FIR, VRT, IR)
b) Size of H₂O cluster in LHR system (GC-MS)
c) Degree of LHR on H-bonding alteration (DRIFT)
d) Efficiency of LHR on H-bonding of cellulose (DSC)
e) Cellulose nano-Fibers test on resultant pulp
f) Verification of hornification removal (FQA)
g) Uniform fiber morphology with tendency to original form i.e. total removal of hornification (TEM)
h) LHR repulping—fiber width increase (Kajaani FS-300)
i) Fiber flexibility and Fiber integrity (SEM)
j) Crystalinity Index, X-ray diffraction
h) BOD and COD tests
i) Tappi standards: Drainability Analysis, Alpha cellulose test, Viscosity measurement, Handsheet preparation, Grammage, Bulk, Burst strength, Tensile strength, Stretch, Tear strength, Brightness, Smoothness, Hemicellulose content.

20. The method of claim 19, in which at least one of the following adjustable factors is measured and controlled to assist in optimization of the method:
a) Type of recyclable lignocellulosic material (LCC level);
b) LHR concentration;
c) Repulping consistency;
d) Mechanical action of pulper;
e) Temperature;
f) Repulping time;
g) Strength and physical properties of the required end product.
